(19) United States
(12) Patent Application Publication
(10) Pub. No.: US 2025/0389960 A1
(43) Pub. Date: Dec. 25, 2025

(54) OPTICAL MODULE AND HEAD-MOUNTED DISPLAY DEVICE

(71) Applicant: Goertek Optical Technology Co., Ltd., Shandong (CN)

(72) Inventor: Wenbao Song, Shandong (CN)

(73) Assignee: Goertek Optical Technology Co., Ltd., Shandong (CN)

(21) Appl. No.: 18/879,850

(22) PCT Filed: Feb. 23, 2023
(86) PCT No.: PCT/CN2023/077857

§ 371 Date: Dec. 30, 2024

(30) Foreign Application Priority Data
Jun. 30, 2022 (CN) 202210768807.4

(51) Int. Cl. G02B 27/01; G02B 27/28

(52) U.S. Cl. CPC G02B 27/0172; G02B 27/286

(57) ABSTRACT

The disclosure provides an optical module and a head mounted display. The optical module includes a first lens and a second lens, a beam splitting element, a first phase retarder, and a polarizing reflective element, wherein the first phase retarder is located between the beam splitting element and the polarizing reflective element; the beam splitting element is located on one side of the second lens, and the first phase retarder and the polarizing reflective element are located on either side of the first lens; wherein a ratio of an optical path length between folded optical paths of the optical module to a total optical path length of the optical module is 0.2 to 0.3.

### CROSS-REFERENCE TO RELATED APPLICATIONS

The present disclosure is a National Stage of International Application No. PCT/CN2023/077857, filed on Feb. 23, 2023, which claims priority to Chinese Patent Application No. 202210768807.4, filed on Jun. 30, 2022, both of which are hereby incorporated by reference in their entireties.

### TECHNICAL FIELD

The present disclosure relates to the technical field of optical display, and particularly to an optical module and a head mounted display.

### BACKGROUND

In recent years, virtual reality (VR) devices have experienced rapid development. However, current VR devices generally suffer from issues of large size and heavy weight, which to some extent detract from the user experience. Compared with traditional aspheric and Fresnel VR optical structures, the folded optical path design for VR optical structures offers a significant advantage in terms of reducing the overall length of the optical module, thereby facilitating the miniaturization trend of VR optical modules. In existing solutions, however, the reduction in the overall length of the optical module has typically been achieved by decreasing the number of optical lenses or optical films, which may compromise imaging quality.

### SUMMARY

An objective of the present disclosure is to provide new technical solutions for an optical module and a head mounted display, which can effectively reduce the overall length of the optical module.

According to an aspect of the present disclosure, an optical module is provided, which includes a first lens and a second lens;
the optical module further includes a beam splitting element, a first phase retarder, and a polarizing reflective element, wherein the first phase retarder is located between the beam splitting element and the polarizing reflective element; the beam splitting element is located on either side of the second lens, and the first phase retarder and the polarizing reflective element are located on either side of the first lens; and
wherein a ratio of an optical path length between folded optical paths of the optical module to an overall optical path length of the optical module is 0.2 to 0.3.

Optionally, the optical path length between folded optical paths is: sum of products of thickness and refractive index of each element located between the polarizing reflective element and the beam splitting element, wherein the products includes product of an air gap and air refractive index; and
the overall optical path length of the optical module is: sum of products of thickness and refractive index of each element through which light sequentially traverses in the optical module, wherein the products includes products of air gaps and air refractive index.

Optionally, the first lens includes a first surface and a second surface, the second lens includes a third surface and a fourth surface, wherein the second surface and the third surface are adjacent with an air gap therebetween;
the beam splitting element is provided on the fourth surface of the second lens, and the first phase retarder is provided on the third surface of the second lens; and
the polarizing reflective element is provided on the second surface of the first lens. Optionally, the optical path length between folded optical paths is:

$${A}_{12} * {n}_{0} + {T}_{50} * {n}_{50} + {T}_{20} * {n}_{20} ;$$

wherein: A₁₂ is air gap between the first lens and the second lens, and n₀ is air refractive index; T₅₀ is thickness of the first phase retarder, and n₅₀ is refractive index of the first phase retarder; T₂₀ is thickness of the second lens, and n₂₀ is refractive index of the second lens.

Optionally, the optical module further includes a display screen, which has a light-emitting surface configured to emit circularly polarized light or linearly polarized light; when the light-emitting surface of the display screen emits linearly polarized light, a second phase retarder is provided adjacent to the light-emitting surface of the display screen, and is configured to convert linearly polarized light into circularly polarized light.

Optionally, the beam splitting element is located between the first phase retarder and the second phase retarder.

Optionally, the optical module further includes a polarizing element, and the second phase retarder and the polarizing element are laminated to form a laminated composite film, which is provided on the light-emitting surface of the display screen;
the polarizing element is located between the second phase retarder and the light-emitting surface of the display screen, and a screen protection sheet is provided between the light-emitting surface and the laminated composite film.

Optionally, the overall optical path length of the optical module is as follows:

$${T}_{90} * {n}_{90} + {T}_{80} * {n}_{80} + {T}_{70} * {n}_{70} + {A}_{27} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$

wherein: T₉₀ is thickness of the screen protection sheet, n₉₀ is refractive index of the screen protection sheet; T₈₀ is thickness of the polarizing element, n₈₀ is refractive index of the polarizing element; T₇₀ is thickness of the second phase retarder, n₇₀ is refractive index of the second phase retarder; A₂₇ is an air gap between the second lens and the second phase retarder, n₀ is air refractive index; T₂₀ is thickness of the second lens, n₂₀ is refractive index of the second lens; T₅₀ is thickness of the first phase retarder, n₅₀ is refractive index of the first phase retarder; A₁₂ is an air gap between the first lens and the second lens, n₀ is air refractive index; T₆₀ is thickness of the polarizing reflective element, n₆₀ is refractive index of the polarizing reflective element; T₁₀ is thickness of the first lens, and n₁₀ is refractive index of the first lens.

Optionally, the optical module further includes a third lens, wherein the second lens is located between the first lens and the third lens, and the third lens is configured to transmit light.

Optionally, the beam splitting element is located between the second lens and the third lens;
the first phase retarder and the polarizing reflective element are located between the second lens and the first lens.

Optionally, the optical module further includes a display screen, which is provided close to the third lens;
the display screen has a light-emitting surface, which is configured to emit circularly polarized light or linearly polarized light;
when the light-emitting surface of the display screen emits linearly polarized light, a second phase retarder is provided between the light-emitting surface of the display screen and the third lens, and is configured to convert linearly polarized light into circularly polarized light.

Optionally, the beam splitting element is located between the first phase retarder and the second phase retarder.

Optionally, the beam splitting element is provided on a surface of the second lens close to the display screen, the first phase retarder is provided on a surface of the second lens away from the display screen, and the polarizing reflective element is provided on a surface of the first lens close to the display screen;

the optical module further includes a polarizing element, and the second phase retarder and the polarizing element are laminated to form a laminated composite film that is provided on the light-emitting surface of the display screen, wherein the polarizing element is located between the second phase retarder and the light-emitting surface of the display screen, and a screen protection sheet is provided between the light-emitting surface and the laminated composite film.

Optionally, when the optical module further includes a third lens, the overall optical path length of the optical module is:

$${T}_{90} * {n}_{90} + {T}_{80} * {n}_{80} + {T}_{70} * {n}_{70} + {A}_{37} * {n}_{0} + {T}_{30} * {n}_{30} + {A}_{23} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$

wherein: T₉₀ is thickness of the screen protection sheet, n₉₀ is refractive index of the screen protection sheet; T₈₀ is thickness of the polarizing element, n₈₀ is refractive index of the polarizing element; T₇₀ is thickness of the second phase retarder, n₇₀ is refractive index of the second phase retarder; A₃₇ is an air gap between the third lens and the second phase retarder, n₀ is air refractive index; T₃₀ is thickness of the third lens, n₃₀ is refractive index of the third lens; A₂₃ is an air gap between the second lens and the third lens, n₀ is air refractive index; T₂₀ is thickness of the second lens, n₂₀ is refractive index of the second lens; T₅₀ is thickness of the first phase retarder, n₅₀ is refractive index of the first phase retarder; A₁₂ is an air gap between the first lens and the second lens, n₀ is air refractive index; T₆₀ is thickness of the polarizing reflective element, n₆₀ is refractive index of the polarizing reflective element; T₁₀ is thickness of the first lens, and n₁₀ is refractive index of the first lens. According to another aspect of the present disclosure, a head mounted display is provided, which includes:
a housing; and
the above optical module.

The advantages of the present disclosure are as follows:

The embodiments of the present disclosure provide a folded optical paths scheme that adjusts the ratio of the optical path length between folded optical paths to the overall optical path length of the optical module, controlling this ratio within a specific range. This approach can appropriately reduce the total length of the optical module, thereby minimizing its size. Additionally, the optical module can maintain superior imaging quality.

Other features and advantages of the present disclosure will become clear by the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a schematic structural diagram of the optical module according to an embodiment of the present disclosure;

FIG. 2 shows a modulation transfer function (MTF) curve at 450 nm for the optical module shown in FIG. 1;

FIG. 3 shows a modulation transfer function (MTF) curve at 540 nm for the optical module shown in FIG. 1;

FIG. 4 shows a modulation transfer function (MTF) curve at 610 nm for the optical module shown in FIG. 1;

FIG. 5 shows a second schematic structural diagram of the optical module according to an embodiment of the present disclosure;

FIG. 6 shows a third schematic structural diagram of the optical module according to an embodiment of the present disclosure;

FIG. 7 shows a schematic structural diagram of the optical module according to another embodiment of the present disclosure;

FIG. 8 shows a modulation transfer function (MTF) curve at 450 nm for the optical module shown in FIG. 7;

FIG. 9 shows a modulation transfer function (MTF) curve at 540 nm for the optical module shown in FIG. 7;

FIG. 10 shows a modulation transfer function (MTF) curve at 610 nm for the optical module shown in FIG. 7;

FIG. 11 shows a second schematic structural diagram of the optical module according to another embodiment of the present disclosure;

FIG. 12 shows a third schematic structural diagram of the optical module according to another embodiment of the present disclosure.

### DESCRIPTION OF REFERENCE SIGNS

10, first lens; 11, first surface; 12, second surface; 20, second lens; 21, third surface; 22, fourth surface; 30, third lens; 40, beam splitting element; 50, first phase retarder; 60, polarizing reflective element; 70, second phase retarder; 80, polarizing element; 90, display screen; 100, optical axis; 01, stop; 02, light.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

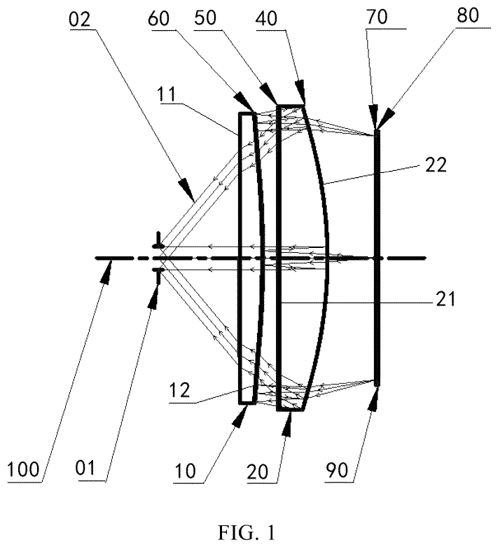

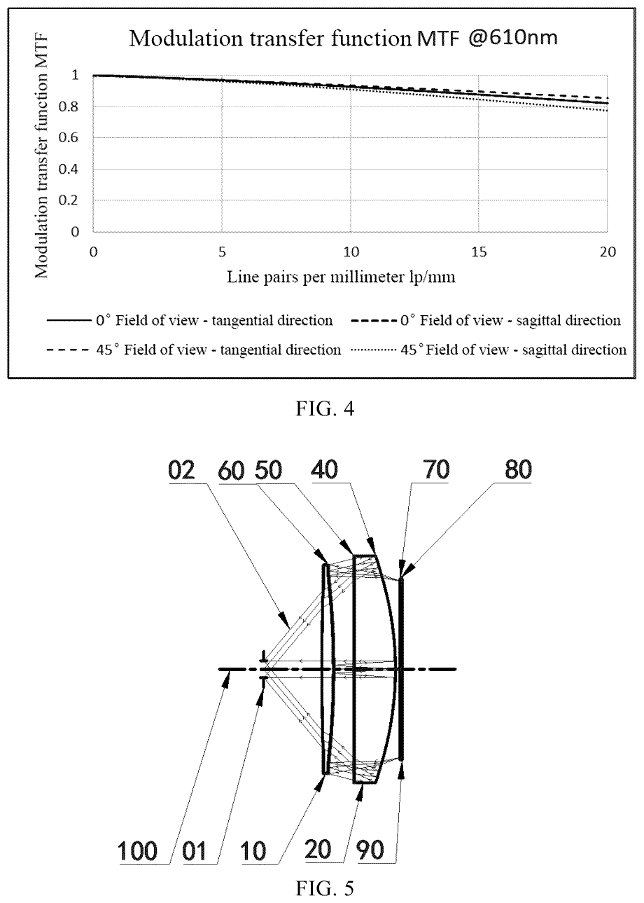

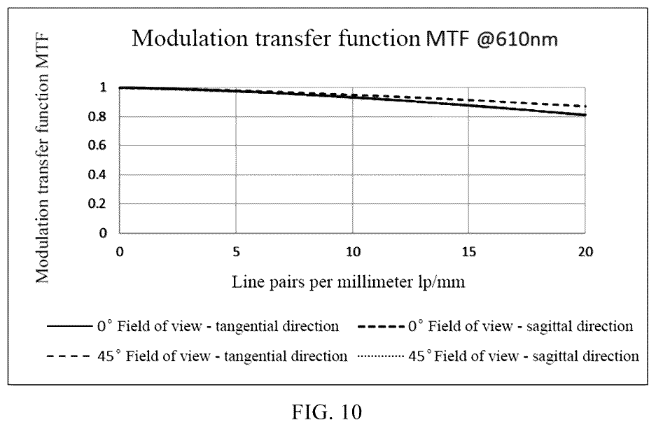

The optical module and the head mounted display provided by the embodiment of the present disclosure are described in detail below with reference to FIGS. 1 to 12.

According to an aspect of an embodiment of the present disclosure, an optical module is provided, which is designed in a folded optical path optical structure, may be suitably applied to a head mounted display (HMD), and has a small size and good imaging quality.

An embodiment of the present disclosure provides an optical module, and as shown in FIG. 1, the optical module includes a first lens 10 and a second lens 20;
the optical module further includes a beam splitting element 40, a first phase retarder 50, and a polarizing reflective element 60, wherein the first phase retarder 50 is located between the beam splitting element 40 and the polarizing reflective element 60; the beam splitting element 40 is located on either side of the second lens 20, and the first phase retarder 50 and the polarizing reflective element 60 are located on either side of the first lens 10;
wherein a ratio of an optical path length between folded optical paths of the optical module to an overall optical path length of the optical module is 0.2 to 0.3.

It should be noted that in the optical module, the folded optical paths are formed between the polarizing reflective element 60 and the beam splitting element 40. Therefore, the optical path length between folded optical paths defined in the embodiment of the present disclosure refers to an optical path length between the polarizing reflective element 60 and the beam splitting element 40.

The optical module provided by the embodiment of the present disclosure may include a lens group, and the lens group may include two optical lenses, namely, the above first lens 10 and second lens 20, such that the number of the optical lenses in the optical path structure may be relatively small, which may reduce the assembly difficulty as well as the size and the weight of the optical module, and also properly reduce production cost.

In addition to the first lens 10 and the second lens 20, the optical module provided by the embodiment of the present disclosure further includes optical elements (optical films) such as the beam splitting element 40, the first phase retarder 50, and the polarizing reflective element 60. In this way, it is possible to enable the optical module to form the folded optical paths structure, which is also beneficial to reducing the size of the optical module.

The optical module provided by the embodiment of the present disclosure is a folded optical paths structure. As shown in FIG. 1, each optical lens and optical element in the optical module may be arranged in a set manner and located on the same optical axis 100. The whole optical path structure is small in size, does not occupy a large space, and is very suitable for smart wearable devices, such as the head mounted device.

The folded optical paths scheme provided by the embodiments of the present disclosure, by adjusting the ratio of the optical path length between the polarizing reflective element 60 and the beam splitting element 40 (or called the optical path length between folded optical paths) to the overall optical path length of the optical module and controlling the ratio within a range of 0.2 to 0.3, may appropriately reduce the total length of the optical module, and thus reduce the size of the optical module; when the optical module is applied to the head mounted device, it is possible to reduce the size of the entire head mounted device, thereby improving the wearing comfort of the user.

Moreover, the optical module provided by the embodiments of the present disclosure may also have better imaging quality, and thus may improve the viewing experience of the user.

It should be noted that in the related art, the size and imaging quality of the optical module are both adjusted by adjusting the number and position of lenses or optical films. However, the scheme provided by the embodiment of the present disclosure is not so. The scheme provided by the embodiment of the present disclosure creatively discovers that by adjusting the ratio of the optical path length between folded optical paths to the overall optical path length of the optical module, it is possible to reduce the emitting angle of the light on the display screen, reduce the imaging brightness difference between the peripheral field of view and the central field of view of the optical module, and improve the quality of the imaging picture.

It should be noted that the total length of the optical module is the distance from the intersection of the first surface 11 of the first lens 10 and the optical axis 100 to the light-emitting surface of the display screen 90.

Here, the beam splitting element 40 is a transflective film, for example, which allows part of light to transmit and another part of the light to be reflected.

It should be noted that the reflectivity of the beam splitting element 40 may be flexibly adjusted according to specific needs, which is not limited in the embodiment of the present disclosure.

Here, the first phase retarder 50 is, for example, a quarter-wave plate (film) or other phase retarders. The phase retarder may be used to change the polarization state of the light in the folded optical path structure. For example, it is configured to convert the linearly polarized light into the circularly polarized light, or converting the circularly polarized light into the linearly polarized light.

Here, the polarizing reflective element 60 is a polarizing reflective film, for example.

The polarizing reflective element 60 is, for example, a polarizing reflective component that reflects horizontally linearly polarized light and transmits vertically linearly polarized light. Alternatively, the polarizing reflective element 60 may also be a polarizing reflective component that reflects a linearly polarized light at any specific angle and transmits a linearly polarized light perpendicular to that angle.

The polarizing reflective element 60 has the transmission axis along which the light transmits, the angle between the transmission axis of the polarizing reflective element 60 and the fast or slow axis of the first phase retarder 50 is set to be 45°.

That is to say, the angle between the transmission axis of the polarizing reflective element 60 and the fast axis of the first phase retarder 50 is set to be 45°, and the angle between the transmission axis of the polarizing reflective element 60 and the slow axis of the first phase retarder 50 is set to be −45°.

The first phase retarder 50 has the fast axis and the slow axis. Here, the light in the same direction as the transmission axis of the polarizing reflective element 60 may transmit through the polarizing reflective element 60, and the light orthogonal to the transmission axis direction of the polarizing reflective element 60 cannot transmit through the polarizing reflective element 60.

In the embodiments of the present disclosure, the first phase retarder 50 may cooperate with the polarizing reflective element 60 to analyze and propagate the light.

Optionally, the first phase retarder 50 and the polarizing reflective element 60 may be independent optical devices, or may be film structures.

In addition, the first phase retarder 50 and the polarizing reflective element 60 may be attached together. Of course, the two may also be arranged spaced apart, which is not limited in the embodiments of the present disclosure.

In the optical module provided by the embodiment of the present disclosure, the beam splitting element 40, the first phase retarder 50, and the polarizing reflective element 60 are located on the same optical axis 100, and the first phase retarder 50 needs to be located between the beam splitting element 40 and the polarizing reflective element 60, but the specific setting position may be flexibly adjusted as needed.

In some examples of the present disclosure, as shown in FIG. 1, the optical path length between folded optical paths is: sum of products of thickness and refractive index of each element located between the polarizing reflective element 60 and the beam splitting element 40, wherein the products includes product of an air gap and air refractive index;

the overall optical path length of the optical module is: sum of products of thickness and refractive index of each element through which light sequentially traverses in the optical module, wherein the products includes product of an air gap and air refractive index.

Here, the overall optical path length of the optical module refers to sum of products of the thickness and refractive index of each element that the incident light sequentially passes through, starting from when the incident light is emitted from the display side until it is emitting from the surface of the first lens 10 close to the stop 01, and includes product of the air gap and the air refractive index.

In the optical module provided by the embodiment of the present disclosure, the ratio of the optical path length between folded optical paths to the overall optical path length of the optical module may be controlled in a range of 0.2 to 0.3. At this time, it is possible to appropriately reduce the total length of the optical module, have very good imaging quality, and have a better viewing experience when the user uses the optical module.

In the optical module provided by the embodiment of the present disclosure, the overall optical path length of the optical module is positively correlated with the focal length of the optical module, and the optical path length between folded optical paths is negatively correlated with the total length of the optical module. Therefore, when the focal length of the entire optical module is constant, the larger the ratio of the optical path length between folded optical paths to the overall optical path length of the optical module, the smaller the total length of the optical module. In this way, it is possible to reduce the size of the optical module appropriately.

Further, in the optical module provided by the embodiment of the present disclosure, the ratio of the optical path length between folded optical paths to the overall optical path length of the optical module may be controlled in a range of 0.22 to 0.3. On this basis, the total length of the optical module can be less than 30 mm. The overall length of the optical module is significantly smaller.

In some examples of the present disclosure, as shown in FIG. 1, the first lens 10 may be located, for example, on a side close to the stop 01, and the second lens 20 may be located, for example, on a side away from the stop 01; at this time, the beam splitting element 40 may be provided on a surface of the second lens 20 away from the stop 01, the first phase retarder 50 may be provided on a surface of the second lens 20 close to the stop 01, and the polarizing reflective element 60 may be provided on a surface of the first lens 10 away from the stop 01.

That is to say, as shown in FIG. 1, when the optical module comprises two lenses, namely the first lens 10 and the second lens 20, the first lens 10 includes a first surface 11 and a second surface 12, the first surface 11 is close to stop 01, and the second surface 12 is away from stop, and the polarizing reflective element 60 may be attached to the second surface 12. The second lens 20 includes a third surface 21 and a fourth surface 22, the third surface 21 is close to stop 01, the fourth surface 22 is away from stop 01, the first phase retarder 50 may be attached to the third surface 21, and the beam splitting element 40 may be provided on the fourth surface 22 by coating.

In the embodiment of the present disclosure, by providing the beam splitting element 40 and the first phase retarder 50 on the second lens 20 and providing the polarizing reflective element 60 on the first lens 10, it is possible to reduce the assembling difficulty of the optical elements and save costs. Here, the first phase retarder 50 and the polarizing reflective element 60 may be affixed to flat surfaces, spherical surfaces, aspherical surfaces, cylindrical surfaces, free-form surfaces, and other forms of surfaces, which is not limited in the embodiments of the present disclosure.

It should be noted that the beam splitting element 40 may also be provided as a separate optical device in the optical path, which may be flexibly selected by the person skilled in the art according to the specific needs and is not specifically limited in the present disclosure.

In addition, the polarizing reflective element 60 and the first phase retarder 50 may also be attached together to form a laminated composite film, and may be provided on the optical element with a variety of contours, so that the polarizing reflective element 60 and the first phase retarder 50 may effectively adapt to the location of the mounting surface.

In some examples of the present disclosure, as shown in FIG. 1, the optical path length between folded optical paths is: A₁₂*n₀+T₅₀*n₅₀+T₂₀*n₂₀;

wherein: A₁₂ is the air gap between the first lens 10 and the second lens 20, and n₀ is air refractive index; T₅₀ is thickness of the first phase retarder 50, and n₅₀ is refractive index of the first phase retarder 50; T₂₀ is thickness of the second lens 20, and n₂₀ is refractive index of the second lens 20.

In a specific embodiment of the present disclosure, as shown in FIG. 1, when the beam splitting element 40 is provided on the fourth surface 22 of the second lens 20, the first phase retarder 50 is provided on the third surface 21 of the second lens 20, and the polarizing reflective element 60 is provided on the second surface 12 of the first lens 10, the element located between the beam splitting element 40 and the polarizing reflective element 60 then includes the second lens 20 and the first phase retarder 50, and also involves the air gap A₁₂ between the first lens 10 and the second lens 20.

Based on this, the calculation of the optical path length between folded optical paths may include multiplying the thickness of the second lens 20 by the refractive index of the second lens 20, multiplying the thickness of the first phase retarder 50 by the refractive index of the first phase retarder 50, and multiplying the air gap between the second lens 20 and the first lens 10 by the air refractive index, and then summing the three products, so as to obtain the optical path length between folded optical paths in the optical module.

It should be noted that when the positions of the beam splitting element 40, the first phase retarder 50, and the polarizing reflective element 60 in the optical path structure are changed, it is necessary to calculate the optical path length between folded optical paths according to the specific situation, wherein the folded optical paths may contain other optical elements or air gaps.

In some examples of the present disclosure, as shown in FIG. 1, the optical module further includes a display screen 90, which has a light-emitting surface configured to emit circularly or linearly polarized light; when the light-emitting surface of the display screen 90 emits linearly polarized light, a second phase retarder 70 is provided adjacent to the light-emitting surface of the display screen 90 and is configured to convert linearly polarized light into circularly polarized light.

For example, the display screen 90 may be located on a side of the beam splitting element 40 facing away from the second lens 20.

For example, the light-emitting surface of the display screen 90 may be attached with a screen protection sheet.

The light emitted from the light-emitting surface of the display screen 90 may be linearly polarized, circularly polarized, or natural light, which is not limited in the embodiments of the present disclosure.

In addition, the display screen 90 may be either an emissive screen or a reflective screen.

Here, the emissive screen includes, but is not limited to, a LCD, LED, OLED, Micro-OLED, and ULED.

Here, the reflective screen includes, but is not limited to, a DMD (Digital Micromirror Device).

That is, in the optical module of the embodiment of the present disclosure, two lenses and a plurality of optical elements may be provided between the stop 01 and the display screen 90, and the position of each optical element in the optical path structure may be flexibly selected according to actual needs, which is not limited in the embodiments of the present disclosure.

In some examples of the present disclosure, as shown in FIG. 1, the beam splitting element 40 may be located between the first phase retarder 50 and the second phase retarder 70.

The setting position of the beam splitting element 40 in the whole optical module is flexible and can be adjusted according to actual needs; however, the first phase retarder 50 needs to be provided between the beam splitting element 40 and the first polarizing reflective element 60.

In some examples of the present disclosure, as shown in FIG. 1, the optical module further comprises a polarizing element 80, and the second phase retarder 70 and the polarizing element 80 are laminated to form a laminated composite film, which is provided on the light-emitting surface of the display screen 90; the polarizing element 80 is located between the second phase retarder 70 and the light-emitting surface of the display screen 90, and a screen protection sheet is provided between the light-emitting surface and the laminated composite film.

Here, the polarizing element 80 may be, for example, a linear polarizing plate. The polarizing element 80 has a transmission axis through which light passes, and the direction of the transmission axis may be along the horizontal direction, the vertical direction, or any other direction.

The light-incident light emitted from the light-emitting surface of the display screen 90 may be converted into the linearly polarized light when passing through the polarizing element 80.

In the embodiments of the present disclosure, the second phase retarder 70 and the polarizing element 80 are arranged in this order along the propagation direction of the light emitted from the light-emitting surface of the display screen 90. Here, the polarizing element 80 has a transmission axis, and the angle between the transmission axis of the polarizing element 80 and the fast axis of the second phase retarder 70 is 45°; the angle may be +45° or −45°.

The second phase retarder 70 has the fast axis and the slow axis. The light in the same direction as the transmission axis of the polarizing element 80 may transmit through the polarizing element 80, and the light perpendicular to the transmission axis direction of the polarizing element 80 cannot transmit through the polarizing element 80.

As shown in FIG. 1, in the embodiment of the present disclosure, both the second phase retarder 70 and the polarizing element 80 are of a film structure, and can be attached together by an optical adhesive to form the laminated composite film, and then the laminated composite film is attached to the light-emitting surface of the display screen 90 by the optical adhesive. In this manner, it is possible to reduce the assembling difficulty of the polarizing element 80 and the second phase retarder 70.

In addition, the polarizing element 80 and the second phase retarder 70 can also be provided spaced apart and at a proper position on the light-emitting side of the display screen 90. At this time, the polarizing element 80 and the second phase retarder 70 may be separate devices.

In a specific embodiment of the present disclosure, as shown in FIG. 1, the optical module includes a first lens 10 and a second lens 20; the first lens 10 is close to the stop 01, and the second lens 20 is away from the stop 01; the beam splitting element 40 is provided on the fourth surface 22 of the second lens 20, the first phase retarder 50 is provided on the third surface 21 of the second lens 20, and the polarizing reflective element 60 is provided on the second surface 12 of the first lens 10; the second phase retarder 70 and the polarizing element 80 are laminated to form a laminated composite film, the laminated composite film is provided on the light-emitting surface of the display screen 90, and a screen protection sheet is provided between the light-emitting surface and the laminated composite film.

According to the optical module provided by the specific embodiments of the present disclosure, the propagation process of the light is as follows:

As shown in FIG. 1, the light emitted by the display screen 90 becomes horizontally linearly polarized light after passing through the polarizing element 80, then becomes left-handed or right-handed circularly polarized light after passing through the second phase retarder 70, and then becomes horizontally linearly polarized light after passing through the beam splitting element 40, the second lens 20 and the first phase retarder 50; it becomes the horizontally linearly polarized light after being reflected by the polarizing reflective element 60, then becomes left-handed or right-handed circularly polarized light after passing through the first phase retarder 50 and the second lens 20, then becomes the right-handed or left-handed circularly polarized light after being reflected by the beam splitting element 40, then becomes the vertically linearly polarized light after passing through the second lens 20 and the first phase retarder 50 again, and then enters the stop 01 after passing through the polarizing reflective element 60 and the first lens 10.

Based on the above example, the overall optical path length of the optical module may be calculated as follows:

$${T}_{90} * {n}_{90} + {T}_{80} * {n}_{80} + {T}_{70} * {n}_{70} + {A}_{27} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$

wherein: T₉₀ is thickness of the screen protection sheet, n₉₀ is refractive index of the screen protection sheet; T₈₀ is thickness of the polarizing element 80, n₈₀ is refractive index of the polarizing element 80; T₇₀ is thickness of the second phase retarder 70, n₇₀ is refractive index of the second phase retarder 70; A₂₇ is an air gap between the second lens 20 and the second phase retarder 70, n₇₀ is air refractive index; T₂₀ is thickness of the second lens 20, n₂₀ is refractive index of the second lens 20; T₅₀ is thickness of the first phase retarder 50, n₅₀ is refractive index of the first phase retarder 50; A₁₂ is an air gap between the first lens 10 and the second lens 20, n₀ is air refractive index; T₆₀ is thickness of the polarizing reflective element 60, n₆₀ is refractive index of the polarizing reflective element 60; T₁₀ is thickness of the first lens 10, and n₁₀ is refractive index of the first lens 10.

As shown in FIG. 1, the overall optical path length of the optical module refers to sum of products of the thickness and refractive index of each element that the light sequentially passes through, starting from when the light is emitted from the display side until the light 02 is emitting from the surface of the first lens 10 close to the stop 01, and includes product of the air gap and the air refractive index.

It should be noted that when the display screen 90 can directly emit the circularly polarized light, the design of polarizing element 80 and second phase retarder 70 may be omitted from the optical module. In this case, when calculating the overall optical path length of the optical module, there is no need to add the second phase retarder 70 and the polarizing element 80 when calculating the overall optical path length of the optical module, and the optical path length between folded optical paths may not be affected.

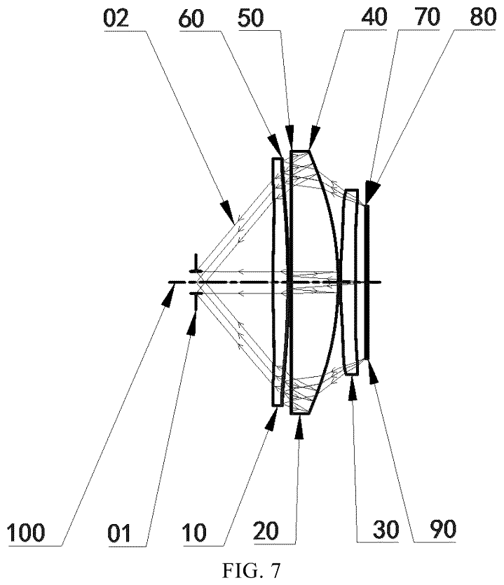

In some examples of the present disclosure, as shown in FIG. 7, the optical module further comprises a third lens 30, wherein the second lens 20 is located between the first lens 10 and the third lens 30, and the third lens 30 is configured to transmit light.

The imaging quality of the optical module may be better improved by adding one lens to the lens group of the optical module, i.e., by adding the above-mentioned third lens 30.

Here, the third lens 30 may be designed to be close to the display screen 90, i.e., it is not within the folded optical paths, and thus, does not affect the optical path length between the folded optical paths.

The introduction of the third lens 30 increases the total length of the optical module. In the embodiments of the present disclosure, the total length of the optical module may be appropriately reduced by controlling the ratio of the optical path length between folded optical paths to the overall optical path length of the optical module. In this way, it is possible to reduce the size of the optical module while improving imaging quality of the optical module.

Optionally, in the case where the optical module comprises three lenses, the ratio of the optical path length between folded optical paths to the overall optical path length of the optical module may be controlled in the range of 0.2 to 0.3. Further, the ratio of the two may be controlled in the range of 0.22 to 0.28, and at this time, the total length of the optical module is reduced. Meanwhile, the imaging quality of the optical module may be effectively improved due to the addition of a new lens in the optical module.

In some examples of the present disclosure, as shown in FIG. 7, the beam splitting element 40 is located between the second lens 20 and the third lens 30; the first phase retarder 50 and the polarizing reflective element 60 are located between the second lens 20 and the first lens 10.

The polarizing reflective element 60 is, for example, a polarizing reflective component that reflects horizontally linearly polarized light and transmits vertically linearly polarized light. Alternatively, the polarizing reflective element 60 may also be a polarizing reflective component that reflects a linearly polarized light at any specific angle and transmits a linearly polarized light perpendicular to that angle.

The polarizing reflective element 60 has the transmission axis along which the light transmits, the angle between the transmission axis of the polarizing reflective element 60 and the fast or slow axis of the first phase retarder 50 is set to be 45°.

The first phase retarder 50 has the fast axis and the slow axis. Here, the light in the same direction as the transmission axis of the polarizing reflective element 60 may transmit through the polarizing reflective element 60, and the light orthogonal to the transmission axis direction of the polarizing reflective element 60 cannot transmit through the polarizing reflective element 60.

In the embodiments of the present disclosure, the first phase retarder 50 cooperates with the polarizing reflective element 60 to analyze and propagate the light.

In some examples of the present disclosure, as shown in FIG. 7, the optical module further includes a display screen 90 provided close to the third lens 30; the display screen 90 has a light-emitting surface configured to emit circularly or linearly polarized light;

when the light-emitting surface of the display screen 90 emits linearly polarized light, a second phase retarder 70 is provided between the light-emitting surface of the display screen 90 and the third lens 30, and is configured to convert linearly polarized light into circularly polarized light.

For example, the light-emitting surface of the display screen 90 may be attached with a screen protection sheet.

The light emitted from the light-emitting surface of the display screen 90 may be linearly polarized, circularly polarized, or natural light, which is not limited in the embodiments of the present disclosure.

In addition, the display screen 90 may be either an emissive screen or a reflective screen.

Here, the emissive screen includes, but is not limited to, a LCD, LED, OLED, Micro-OLED, and ULED.

Here, the reflective screen includes, but is not limited to, a DMD (Digital Micromirror Device).

In some examples of the present disclosure, the beam splitting element 40 is located between the first phase retarder 50 and the second phase retarder 70.

In some examples of the present disclosure, as shown in FIG. 7, the beam splitting element 40 is provided on a surface of the second lens 20 close to the display screen 90. the first phase retarder 50 is provided on a surface of the second lens 20 away from the display screen 90, and the polarizing reflective element 60 is provided on a surface of the first lens 10 close to the display screen 90;

The optical module further comprises a polarizing element 80, and the second phase retarder 70 and the polarizing element 80 are laminated to form a laminated composite film that is provided on the light-emitting surface of the display screen 90, wherein the polarizing element 80 is located between the second phase retarder 70 and the light-emitting surface of the display screen 90, and a screen protection sheet is provided between the light-emitting surface and the laminated composite film

When the optical module includes three lenses, i.e., the first lens 10, the second lens 20, and the third lens 30, the propagation process of the light is as follows:

As shown in FIG. 7, the light emitted by the display screen 90 becomes horizontally linearly polarized light after passing through the polarizing element 80, then becomes left-handed or right-handed circularly polarized light after passing through the second phase retarder 70, and then becomes horizontally linearly polarized light after passing through the third lens 30, the beam splitting element 40, the second lens 20 and the first phase retarder 50; it becomes the horizontally linearly polarized light after being reflected by the polarizing reflective element 60, then becomes left-handed or right-handed circularly polarized light after passing through the first phase retarder 50 and the second lens 20, then becomes the right-handed or left-handed circularly polarized light after being reflected by the beam splitting element 40, then becomes the vertically linearly polarized light after passing through the second lens 20 and the first phase retarder 50 again, and then enters the stop 01 after passing through the polarizing reflective element 60 and the first lens 10.

In some examples of the present disclosure, as shown in FIG. 7, when the optical module further comprises a third lens 30, the overall optical path length of the optical module is:

$${T}_{90} * {n}_{90} + {T}_{80} * {n}_{80} + {T}_{70} * {n}_{70} + {A}_{37} * {n}_{0} + {T}_{30} * {n}_{30} + {A}_{23} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$

wherein: T₉₀ is thickness of the screen protection sheet, n₉₀ is refractive index of the screen protection sheet; T₈₀ is thickness of the polarizing element 80, n₈₀ is refractive index of the polarizing element 80; T₇₀ is thickness of the second phase retarder 70, n₇₀ is refractive index of the second phase retarder 70; A₃₇ is an air gap between the third lens 30 and the second phase retarder 70, n₀ is air refractive index; T₃₀ is thickness of the third lens 30, n₃₀ is refractive index of the third lens 30; A₂₃ is an air gap between the second lens 20 and the third lens 30, n₀ is air refractive index; T₂₀ is thickness of the second lens 20, n₂₀ is refractive index of the second lens 20; T₅₀ is thickness of the first phase retarder 50, n₅₀ is refractive index of the first phase retarder 50; A₁₂ is an air gap between the first lens 10 and the second lens 20, n₀ is air refractive index; T₆₀ is thickness of the polarizing reflective element 60, n₆₀ is refractive index of the polarizing reflective element 60; T₁₀ is thickness of the first lens 10, and n₁₀ is refractive index of the first lens 10.

It should be noted that the third lens 30 is located between the second lens 20 and the display screen 90, and the positions of other elements in the optical path structure are not changed.

In the optical module comprising three lenses, the overall optical path length of the optical module is positively correlated with the focal length of the optical module, and the optical path length between folded optical paths is negatively correlated with the total length of the optical module. The ratio of the optical path length between folded optical paths to the overall optical path length of the optical module is from 0.22 to 0.28, or when the ratio of the overall optical path length of the optical module to the optical path length between folded optical paths is from 3.6 to 4.5, the optical module has better imaging quality.

Hereinafter, the case where the optical module includes two lenses will be described with reference to the first to third embodiments.

### First Embodiment

As shown in FIG. 1, the optical module includes a first lens 10 and a second lens 20 sequentially along an optical axis 100 direction, the first lens 10 is located on a side close to the stop 01, and the second lens 20 is located on a side away from the stop 01; the first lens 10 includes a first surface (front surface) 11 and a second surface (rear surface) 12, the first surface 11 is close to the stop 01, the second surface 12 faces away from the stop 01, and the polarizing reflective element 60 is provided on the second surface 12; the second lens 20 includes a third surface (front surface) 21 and a fourth surface (rear surface) 22, wherein the third surface 21 is adjacent to the second surface 12, the fourth surface 22 is close to the display side, the beam splitting element 40 is provided on the fourth surface 22, and the first phase retarder 50 is provided on the third surface 21;
the display screen 90 has a light-emitting surface configured to emit incident light;
the optical module further includes an second phase retarder 70 and a polarizing element 80, which are laminated to form a laminated composite film, and the laminated composite film is provided on the light-emitting surface of the display screen 90; a screen protection sheet may be provided between the light-emitting surface and the laminated composite film layer.

In the optical module shown in FIG. 1, the total length of the optical module is a distance from the intersection of the first surface 11 of the first lens 10 and the optical axis 100 to the light-emitting surface of the display screen 90. In the first embodiment, the total length of the optical module is 24.0 mm.

The optical path length between folded optical paths is: multiplying the air gap of 2.6 mm between the first lens 10 and the second lens 20 by the air refractive index of 1+the thickness of 0.08 mm of the first phase retarder 50 by its refractive index of 1.5+the thickness of 8.4 mm of the second lens 20 by its refractive index of 1.54, resulting in the optical path length between folded optical paths of 15.7 mm.

The overall optical path length of the optical module is: multiplying the thickness of 0.34 mm of the screen protection sheet of the display screen 90 by its refractive index of 1.52+the thickness of 0.08 mm of the polarizing element 80 by its refractive index of 1.5+the thickness of 0.08 mm of the second phase retarder 70 by its refractive index of 1.5+the air gap of 8.3 mm between the second lens 20 and the second phase retarder 70 by the air refractive index of 1.0+the thickness of 8.4 mm of the second lens 20 by its refractive index of 1.54+the thickness of 0.08 mm of the first phase retarder 50 by its refractive index of 1.5+the air gap of 2.6 mm between the first lens 10 and the second lens 20 by the air refractive index of 1.0+the air gap of 2.6 mm between the first lens 10 and the second lens 20 by the air refractive index of 1.0+the thickness of 0.08 mm of the first phase retarder 50 by its refractive index of 1.5+the thickness of 8.4 mm of the second lens 20 by its refractive index of 1.54+the thickness of 8.4 mm of the second lens 20 by its refractive index of 1.54+the thickness of 0.08 mm of the first phase retarder 50 by its refractive index of 1.5+the air gap of 2.6 mm between the first lens 10 and the second lens 20 by the air refractive index of 1+the thickness of 0.08 mm of the polarizing reflective element 60 by its refractive index of 1.5+the thickness of 4.0 mm of the first lens 10 by its refractive index of 1.54, resulting in the overall optical path length of the optical module of 62.3 mm.

In this way, the ratio of the optical path length between folded optical paths to the overall optical path length of the optical system is 0.25.

Specific parameters of the optical module provided by the first embodiment are shown in Table 1.

TABLE 1
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | K26R | front | 4.0 | −2600.0 | 9.53E−006 | −1.12E−007 | 6.54E−010 |
| lens 10 | | surface | | | | | |
| | | rear | 0 | −170.0 | 4.50E−006 | −3.12E−008 | 1.74E−010 |
| | | surface | | | | | |
| polarizing | / | front | 0.08 | −170.0 | 4.50E−006 | −3.12E−008 | 1.74E−010 |
| reflective | | surface | | | | | |
| element 60 | | rear | 2.6 | −170.0 | 4.50E−006 | −3.12E−008 | 1.74E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 8.4 | Inf | / | / | / |
| lens 20 | | surface | | | | | |
| | | rear | 8.3 | −75.0 | 2.14E−006 | −6.67E−009 | 1.80E−011 |
| | | surface | | | | | |
| second | / | front | 0.08 | Inf | / | / | / |
| phase | | surface | | | | | |
| retarder 70 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen 90 | | | | | | | |

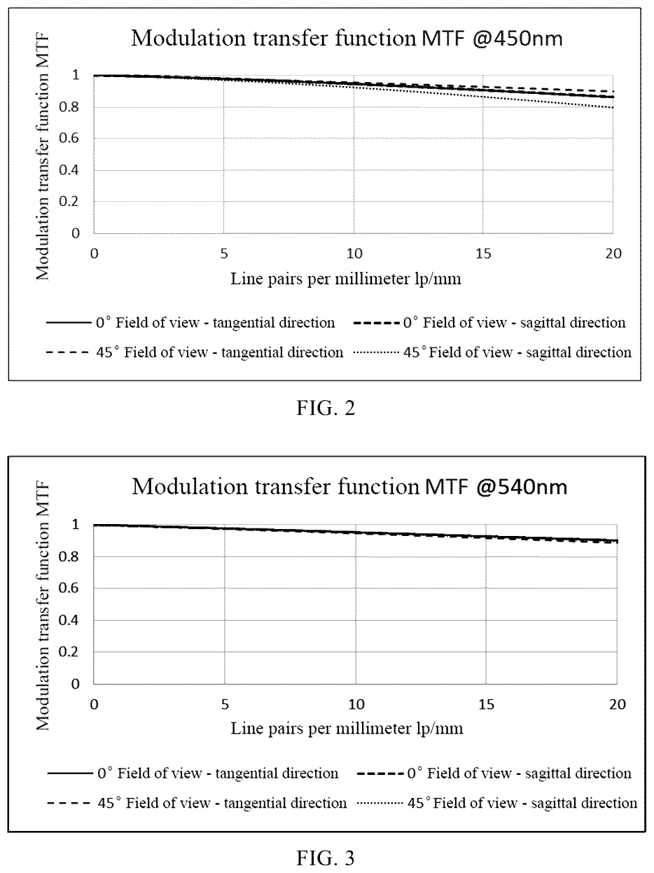

FIGS. 2, 3 and 4 respectively show modulation transfer function (MTF) curves at 450 nm, 540 nm and 610 nm for the optical module according to an embodiment of the present disclosure.

It can be seen from FIGS. 2 to 4 that: at 201 p/mm spatial frequency:
the MTF value at the wavelength of 450 nm for the optical module is higher than 0.7;
the MTF value at the wavelength of 540 nm for the optical module is higher than 0.7;
the MTF value at the wavelength of 610 nm for the optical module is higher than 0.6;

The optical module provided by the embodiment of the present disclosure may form a clear image.

### Second Embodiment

The structural parameters of the optical module provided by the second embodiment are shown in Table 2.

FIG. 5 shows the structure of the optical module, which is different from the first embodiment in that:
the overall length of the optical module is 19.1 mm;
the optical path length between folded optical paths is 20.0 mm, and the overall optical path length of the optical module is 66.1 mm;
the ratio of the optical path length between folded optical paths to the overall optical path length of the optical module is 0.30.

TABLE 2
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | K26R | front | 2.7 | −126.0 | 1.42E−005 | −1.22E−007 | 6.74E−010 |
| lens 10 | | surface | | | | | |
| | | rear | 0 | −170.0 | 5.78E−006 | −3.15E−007 | 1.54E−010 |
| | | surface | | | | | |
| polarizing | / | front | 0.08 | −170.0 | 5.78E−006 | −3.15E−007 | 1.54E−010 |
| reflective | | surface | | | | | |
| element 60 | | rear | 4.8 | −170.0 | 5.78E−006 | −3.15E−007 | 1.54E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 9.8 | Inf | / | / | / |
| lens 20 | | surface | | | | | |
| | | rear | 1.1 | −74.0 | 2.80E−006 | −5.77E−009 | 1.40E−011 |
| | | surface | | | | | |
| second | / | front | 0.08 | Inf | / | / | / |
| phase | | surface | | | | | |
| retarder 70 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen 90 | | | | | | | |

The MTF curves of the optical module provided by the second embodiment of the present disclosure at 450 nm, 540 nm, 610 nm, and 201 p/mm spatial frequency are similar to the MTF curves shown in FIGS. 2 to 4. The optical module provided by the second embodiment may also form a clear image, and have a smaller overall length.

### Third Embodiment

The structural parameters of the optical module provided by the third embodiment are shown in Table 3.

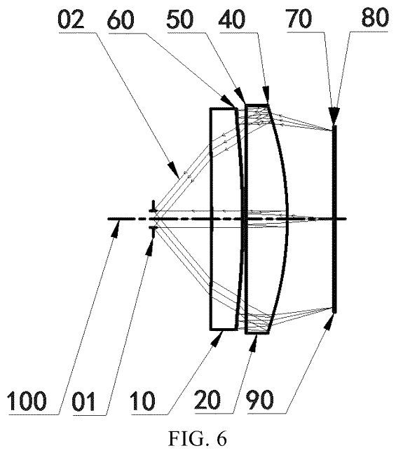

FIG. 6 shows the structure of the optical module, which is different from the first embodiment in that:
the overall length of the optical module is 29.5 mm;
the optical path length between folded optical paths is 15.8 mm, and the overall optical path length of the optical module is 70.7 mm;
the ratio of the optical path length between folded optical paths to the overall optical path length of the optical module is 0.22.

TABLE 3
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | K26R | front | 7.4 | −800.0 | 9.62E−006 | −1.22E−007 | 6.62E−010 |
| lens 10 | | surface | | | | | |
| | | rear | 0 | −172.0 | 5.65E−006 | −3.45E−007 | 1.09E−010 |
| | | surface | | | | | |
| polarizing | / | front | 0.08 | −172.0 | 5.65E−006 | −3.45E−007 | 1.09E−010 |
| reflective | | surface | | | | | |
| element 60 | | rear | 0.6 | −172.0 | 5.65E−006 | −3.45E−007 | 1.09E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 9.8 | Inf | / | / | / |
| lens 20 | | surface | | | | | |
| | | rear | 11.0 | −76.0 | 2.40E−006 | −7.89E−009 | 1.88E−011 |
| | | surface | | | | | |
| second | / | front | 0.08 | Inf | / | / | / |
| phase | | surface | | | | | |
| retarder 70 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen 90 | | | | | | | |

The MTF curves of the optical module provided by the third embodiment of the present disclosure at 450 nm, 540 nm, 610 nm, and 201 p/mm spatial frequency are similar to the MTF curves shown in FIGS. 2 to 4. The optical module provided by the third embodiment may also form a clear image, and have a smaller overall length.

Hereinafter, the case where the optical module includes two lenses will be described with reference to the fourth to sixth embodiments.

### Fourth Embodiment

As shown in FIG. 7, the optical module includes a first lens 10, a second lens 20 and a third lens 30 sequentially along an optical axis 100 direction, the first lens 10 is located on a side close to the stop 01, the third lens 30 is located on a side close to the display screen 90, and the second lens 20 is located between the first lens 10 and the third lens 30, the first lens 10 includes a first surface (front surface) 11 and a second surface (rear surface) 12, the first surface 11 is close to the stop 01, the second surface 12 faces away from the stop 01, and the polarizing reflective element 60 is provided on the second surface 12; the second lens 20 includes a third surface (front surface) 21 and a fourth surface (rear surface) 22, the third surface 21 is adjacent to the second surface 12, the fourth surface 22 is away from the stop 01, the beam splitting element 40 is provided on the fourth surface 22, and the first phase retarder 50 is provided on the third surface 21;
the display screen 90 has a light-emitting surface configured to emit incident light;
the optical module further includes an second phase retarder 70 and a polarizing element 80, which are laminated to form a laminated composite film, and the laminated composite film is provided on the light-emitting surface of the display screen 90; a screen protection sheet may be provided between the light-emitting surface and the laminated composite film layer.

In the optical module shown in FIG. 7, the total length of the optical module is a distance from the intersection of the first surface 11 of the first lens 10 and the optical axis 100 to the light-emitting surface of the display screen 90. In the fourth embodiment, the total length of the optical module is 17.2 mm.

The optical path length between folded optical paths is:
multiplying the air gap of 0.4 mm between the first lens 10 and the second lens 20 by the air refractive index of 1+the thickness of 0.08 mm of the first phase retarder 50 by its refractive index of 1.5+the thickness of 8.5 mm of the second lens 20 by its refractive index of 1.54, resulting in the optical path length between folded optical paths of 13.6 mm.

The overall optical path length of the optical module is:
multiplying the thickness of 0.4 mm of the screen protection sheet of the display screen 90 by its refractive index of 1.52+the thickness of 0.08 mm of the polarizing element 80 by its refractive index of 1.5+the thickness of 0.08 mm of the second phase retarder 70 by its refractive index of 1.5+the air gap of 1.7 mm between the third lens 30 and the second phase retarder 70 by the air refractive index of 1+the thickness of 2.8 mm of the third lens 30 by its refractive index of 1.54+the air gap of 0.4 mm between the third lens 30 and the second lens 20 by the air refractive index of 1+the thickness of 8.4 mm of the second lens 20 by its refractive index of 1.54+the thickness of 0.08 mm of the first phase retarder 50 by its refractive index of 1.5+the air gap of 0.4 mm between the first lens 10 and the second lens 20 by the air refractive index of 1+the air gap of 0.4 mm between the first lens 10 and the second lens 20 by the air refractive index of 1+the thickness of 0.08 mm of the first phase retarder 50 by its refractive index of 1.5+the thickness of 8.5 mm of the second lens 20 by its refractive index of 1.54+the thickness of 8.5 mm of the second lens 20 by its refractive index of 1.54+the thickness of 0.08 mm of the first phase retarder 50 by its refractive index of 1.5+the air gap of 0.4 mm between the first lens 10 and the second lens 20 by the air refractive index of 1+the thickness of 0.08 mm of the polarizing reflective element 60 by its refractive index of 1.5+the thickness of 2.7 mm of the first lens 10 by its refractive index of 1.64, resulting in the overall optical path length of the optical module of 52.5 mm.

In this way, the ratio of the optical path length between folded optical paths to the overall optical path length of the optical system is 0.26.

Specific parameters of the optical module provided by the fourth embodiment are shown in Table 4.

TABLE 4
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | OKP-1 | front | 2.7 | 235.0 | −5.77E−005 | −8.90E−010 | / |
| lens 10 | | surface | | | | | |
| | | rear | 0 | −170.0 | 1.50E−006 | −5.12E−008 | 2.74E−010 |
| | | surface | | | | | |
| polarizing | / | front | 0.08 | −170.0 | 1.50E−006 | −5.12E−008 | 2.74E−010 |
| reflective | | surface | | | | | |
| element 60 | | rear | 0.4 | −170.0 | 1.50E−006 | −5.12E−008 | 2.74E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 8.5 | Inf | / | / | / |
| lens 20 | | surface | | | | | |
| | | rear | 0.4 | −50.0 | 1.14E−006 | 1.67E−009 | −8.80E−012 |
| | | surface | | | | | |
| Third | APEL | front | 2.8 | 60.0 | 5.84E−005 | 1.64E−007 | −6.80E−012 |
| lens 30 | | surface | | | | | |
| | | rear | 1.7 | −75.0 | 2.84E−005 | −5.64E−007 | / |
| | | surface | | | | | |
| second | / | front | 0.08 | Inf | / | / | / |
| phase | | surface | | | | | |
| retarder 70 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen | | | | | | | |

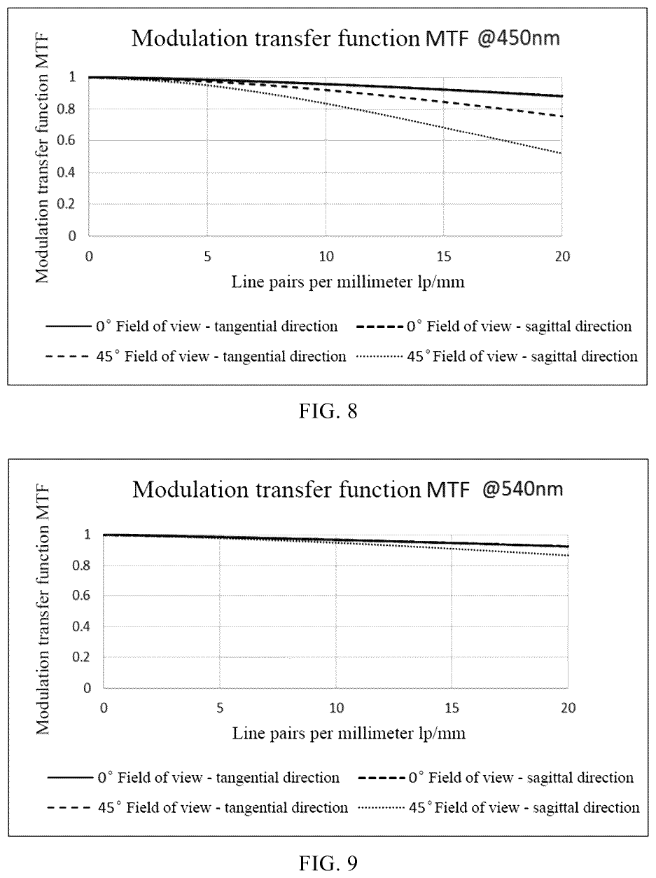

FIGS. 8, 9 and 10 respectively show modulation transfer function (MTF) curves of the optical module according to an embodiment of the present disclosure at 450 nm, 540 nm and 610 nm.

It can be seen from FIGS. 8 to 10 that: at 201 p/mm spatial frequency:
the MTF value at the wavelength of 450 nm for the optical module is higher than 0.5;
the MTF value at the wavelength of 540 nm for the optical module is higher than 0.8;
the MTF value at the wavelength of 610 nm for the optical module is higher than 0.6;

The optical module provided by the embodiment of the present disclosure may form a clear image.

### Fifth Embodiment

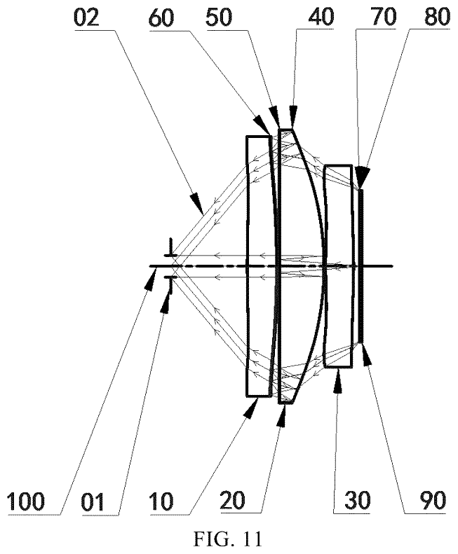

The structural parameters of the optical module provided by the fifth embodiment are shown in Table 5. FIG. 11 shows the structure of the optical module, which is different from the fourth embodiment in that:
the overall length of the optical module is 20.8 mm;
the optical path length between folded optical paths is 12.4 mm, and the overall optical path length of the optical module is 55.8 mm;
the ratio of the optical path length between folded optical paths to the overall optical path length of the optical module is 0.22.

TABLE 5
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | OKP-1 | front | 5.4 | 230.0 | −5.97E−006 | −1.30E−009 | / |
| lens 10 | | surface | | | | | |
| | | rear | 0 | −180.0 | −1.60E−006 | 4.76E−008 | 2.14E−010 |
| | | surface | | | | | |
| polarizing | / | front | 0.08 | −180.0 | −1.60E−006 | 4.76E−008 | 2.14E−010 |
| reflective | | surface | | | | | |
| element 60 | | rear | 0.3 | −180.0 | −1.60E−006 | 4.76E−008 | 2.14E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 8.0 | Inf | / | / | / |
| lens 20 | | surface | | | | | |
| | | rear | 0.3 | −54.0 | −8.64E−008 | 1.17E−009 | −9.80E−012 |
| | | surface | | | | | |
| third | APEL | front | 5.1 | 96.0 | −5.34E−005 | 1.04E−007 | −2.80E−012 |
| lens 30 | | surface | | | | | |
| | | rear | 1.0 | −110.0 | 2.48E−005 | −5.24E−007 | / |
| | | surface | | | | | |
| second | / | front | 0.08 | Inf | / | / | / |
| phase | | surface | | | | | |
| retarder 70 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen 90 | | | | | | | |

The MTF curves of the optical module provided by the fifth embodiment of the present disclosure at 450 nm, 540 nm, 610 nm, and 201 p/mm spatial frequency are similar to the MTF curves shown in FIGS. 8 to 10. The optical module provided by the fifth embodiment may also form a clear image, and have a smaller overall length.

### Sixth Embodiment

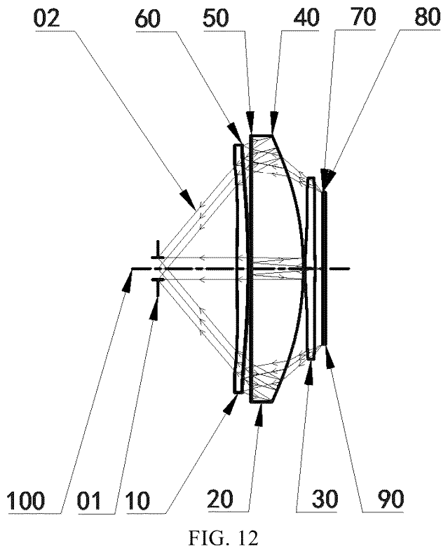

The structural parameters of the optical module provided by the sixth embodiment are shown in Table 6. FIG. 12 shows the structure of the optical module, which is different from the fourth embodiment in that:
the overall length of the optical module is 16 mm;
the optical path length between folded optical paths is 15 mm, and the overall optical path length of the optical module is 53.6 mm;
the ratio of the optical path length between folded optical paths to the overall optical path length of the optical module is 0.28.

TABLE 6
structural parameters table

| | | | | | Fourth- | Sixth- | Eighth- |
|---|---|---|---|---|---|---|---|
| | | | Thickness/ | Curvature | order | order | order |
| | | | Gap | radius | aspheric | aspheric | aspheric |
| Part | Material | Surface | mm | mm | coefficient | coefficient | coefficient |
| stop 01 | / | / | 14 | Inf | / | / | / |
| first | OKP-1 | front | 2.0 | 380.0 | −6.39E−006 | −1.34E−009 | / |
| lens 10 | | surface | | | | | |
| | | rear | 0 | −175.0 | −1.37E−006 | 5.02E−008 | 1.14E−010 |
| | | surface | | | | | |
| polarizing | / | front | 0.08 | −175.0 | −1.37E−006 | 5.02E−008 | 1.14E−010 |
| reflective | | surface | | | | | |
| element 60 | | rear | 0.4 | −175.0 | −1.37E−006 | 5.02E−008 | 1.14E−010 |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| second | APEL | front | 9.4 | Inf | / | / | / |
| lens 20 | | surface | | | | | |
| | | rear | 0.3 | −54.0 | −7.14E−008 | 9.17E−010 | −9.82E−012 |
| | | surface | | | | | |
| third | APEL | front | 1.8 | 96.0 | −5.58E−005 | 1.14E−007 | −2.20E−012 |
| lens 30 | | surface | | | | | |
| | | rear | 1.4 | −110.0 | 2.68E−005 | −6.24E−008 | / |
| | | surface | | | | | |
| first phase | / | front | 0.08 | Inf | / | / | / |
| retarder 70 | | surface | | | | | |
| | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| light- | / | front | 0 | Inf | / | / | / |
| emitting | | surface | | | | | |
| surface of | | | | | | | |
| display | | | | | | | |
| screen 90 | | | | | | | |

The MTF curves of the optical module provided by the sixth embodiment of the present disclosure at 450 nm, 540 nm, 610 nm, and 201 p/mm spatial frequency are similar to the MTF curves shown in FIGS. 8 to 10. The optical module provided by the sixth embodiment may also form a clear image, and have a smaller overall length.

According to another aspect of an embodiment of the present disclosure, a head mounted display is provided, which includes a housing and above optical module.

The head mounted display is, for example, a VR head mounted device, including VR glasses or a VR helmet, which is not specifically limited in the embodiment of the present disclosure.

The specific implementation of the head mounted display in the embodiment of the present disclosure may refer to the embodiments of the above optical module, and therefore possesses at least all the beneficial effects brought by the technical solutions of the above embodiments, which will not be repeated herein.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a first lens and a second lens,
a beam splitting element,
a first phase retarder, and
a polarizing reflective element,
wherein the first phase retarder is located between the beam splitting element and the polarizing reflective element, the beam splitting element is located on a side of the second lens, and the first phase retarder and the polarizing reflective element are located on a side of the first lens;
wherein a ratio of an optical path length between folded optical paths of the optical module to a total optical path length of the optical module is from 0.2 to 0.3.

2. The optical module according to claim 1, wherein the optical path length between folded optical paths is a sum of products of thickness and refractive index of each element located between the polarizing reflective element and the beam splitting element, wherein the products comprises a product of width of air gap and air refractive index; and
the total optical path length of the optical module is a sum of products of thickness and refractive index of each element through which light sequentially traverses in the optical module, wherein the products comprises a product of width of air gap and air refractive index.

3. The optical module according to claim 1, wherein the first lens comprises a first surface and a second surface, the second lens comprises a third surface and a fourth surface, wherein the second surface and the third surface are adjacent with an air gap therebetween;
the beam splitting element is provided on the fourth surface of the second lens, and the first phase retarder is provided on the third surface of the second lens;
the polarizing reflective element is provided on the second surface of the first lens.

4. The optical module according to claim 3, wherein the optical path length between folded optical paths is:
$${A}_{12} * {n}_{0} + {T}_{50} * {n}_{50} + {T}_{20} * {n}_{20} ;$$
wherein:
A₁₂ is width of air gap between the first lens and the second lens, and n₀ is air refractive index;
T₅₀ is thickness of the first phase retarder, and n₅₀ is refractive index of the first phase retarder; and
T₂₀ is thickness of the second lens, and n₂₀ is refractive index of the second lens.

5. The optical module according to claim 3, further comprises a display screen with a light-emitting surface configured to emit circularly polarized light or linearly polarized light;
when the light-emitting surface of the display screen emits the linearly polarized light, a second phase retarder is provided adjacent to the light-emitting surface of the display screen, such that the linearly polarized light is converted into the circularly polarized light.

6. The optical module according to claim 5, wherein the beam splitting element is located between the first phase retarder and the second phase retarder.

7. The optical module according to claim 5, further comprises a polarizing element and a screen protection sheet, wherein the second phase retarder and the polarizing element are laminated to form a laminated composite film, which is provided on the light-emitting surface of the display screen;
the polarizing element is located between the second phase retarder and the light-emitting surface of the display screen, and the screen protection sheet is provided between the light-emitting surface and the laminated composite film.

8. The optical module according to claim 7, wherein
the total optical path length of the optical module is as follows:
$${T}_{90} * {n}_{90} + {T}_{80} * {n}_{80} + {T}_{70} * {n}_{70} + {A}_{27} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$
wherein:
T₉₀ is thickness of the screen protection sheet, n₉₀ is refractive index of the screen protection sheet;
T₈₀ is thickness of the polarizing element, n₈₀ is refractive index of the polarizing element;
T₇₀ is thickness of the second phase retarder, n₇₀ is refractive index of the second phase retarder;
A₂₇ is width of air gap between the second lens and the second phase retarder, n₀ is air refractive index;
T₂₀ is thickness of the second lens, n₂₀ is refractive index of the second lens;
T₅₀ is thickness of the first phase retarder, n₅₀ is refractive index of the first phase retarder;
A₁₂ is width of air gap between the first lens and the second lens, n₀ is air refractive index;
T₆₀ is thickness of the polarizing reflective element, n₆₀ is refractive index of the polarizing reflective element; and
T₁₀ is thickness of the first lens, and n₁₀ is refractive index of the first lens.

9. The optical module according to claim 1, comprises a third lens configured to transmit light, wherein the second lens is located between the first lens and the third lens.

10. The optical module according to claim 9, wherein the beam splitting element is located between the second lens and the third lens;
the first phase retarder and the polarizing reflective element are located between the second lens and the first lens.

11. The optical module according to claim 10, further comprises a display screen provided close to the third lens and a second phase retarder,
wherein the display screen has-comprises a light-emitting surface, configured to emit circularly polarized light or linearly polarized light;
when the light-emitting surface of the display screen emits the linearly polarized light, the second phase retarder is provided between the light-emitting surface of the display screen and the third lens such that the linearly polarized light is converted into the circularly polarized light.

12. The optical module according to claim 11, wherein the beam splitting element is located between the first phase retarder and the second phase retarder.

13. The optical module according to claim 11, further comprises a polarizing element and a screen protection sheet,
wherein the beam splitting element is provided on a surface of the second lens proximate to the display screen, the first phase retarder is provided on a surface of the second lens distal to the display screen, and the polarizing reflective element is provided on a surface of the first lens proximate to the display screen;
wherein the second phase retarder and the polarizing element are laminated to form a laminated composite film that is provided on the light-emitting surface of the display screen, and the polarizing element is located between the second phase retarder and the light-emitting surface of the display screen, and the screen protection sheet is provided between the light-emitting surface and the laminated composite film.

14. The optical module according to claim 13, further comprises a third lens, the total optical path length of the optical module is:
$${T}_{90} * {n}_{90} + {T}_{80} * {n}_{80} + {T}_{70} * {n}_{70} + {A}_{37} * {n}_{0} + {T}_{30} * {n}_{30} + {A}_{23} * {n}_{0} + {T}_{20} * {n}_{20} + {T}_{50} * {n}_{50} + {A}_{12} * {n}_{0} + {A}_{12} * {n}_{0} + {T}_{50} * {n}_{50} + {T}_{20} * {n}_{20} + {T}_{20} * {n}_{20} + {T}_{50} * {n}_{50} + {A}_{12} * {n}_{0} + {T}_{60} * {n}_{60} + {T}_{10} * {n}_{10} ;$$
wherein:
T₉₀ is thickness of the screen protection sheet, n₉₀ is refractive index of the screen protection sheet;
T₈₀ is thickness of the polarizing element, n₈₀ is refractive index of the polarizing element;
T₇₀ is thickness of the second phase retarder, n₇₀ is refractive index of the second phase retarder;
A₃₇ is width of an air gap between the third lens and the second phase retarder, n₀ is air refractive index;
T₃₀ is thickness of the third lens, n₃₀ is refractive index of the third lens;
A₂₃ is width of air gap between the second lens and the third lens, n₀ is air refractive index;
T₂₀ is thickness of the second lens, n₂₀ is refractive index of the second lens;
T₅₀ is thickness of the first phase retarder, n₅₀ is refractive index of the first phase retarder;
A₁₂ is width of air gap between the first lens and the second lens, n₀ is air refractive index;
T₆₀ is thickness of the polarizing reflective element, n₆₀ is refractive index of the polarizing reflective element; and
T₁₀ is thickness of the first lens, and n₁₀ is refractive index of the first lens.

15. A head mounted display, comprising:
a housing; and
an optical module according to claim 1.
